(19) United States
(12) Patent Application Publication
(10) Pub. No.: US 2026/0005624 A1
(43) Pub. Date: Jan. 1, 2026

(54) Device and Method for Controlling Switch Module, Three-Phase Inverter and Program Product

(71) Applicant: Robert Bosch GmbH, Stuttgart (DE)

(72) Inventor: Hao Yu, Shanghai (CN)

(21) Appl. No.: 19/250,741

(22) Filed: Jun. 26, 2025

(30) Foreign Application Priority Data
Jun. 28, 2024 (CN) 2024 1086 4837.4

(51) Int. Cl. H02M 7/5387; H02M 1/00; H02M 1/088

(52) U.S. Cl. CPC H02M 7/53873; H02M 1/0009; H02M 1/0048; H02M 1/088

(57) ABSTRACT

A device and method for controlling a switch module, a three-phase inverter, and a program product are disclosed. The switch module includes a plurality of switches in parallel. The device for controlling the switch module includes (i) a current acquisition module configured to acquire a total expected current flowing through a plurality of switches of the switch module, (ii) a power loss determination module configured to determine a plurality of power losses of a plurality of switch combinations when at least one switch of the plurality of switches is turned on based on the total expected current acquired, and (iii) a turn-on switch number determination module configured to determine a target number of the switches turned on for the total expected current based on the plurality of power losses determined. The device for controlling the switch module according to the present disclosure is capable of changing the number of switches turned on in the plurality of switches according to the total expected current to achieve a lower switch power loss.

This application claims priority under 35 U.S.C. § 119 to application no. CN 2024 1086 4837.4, filed on Jun. 28, 2024 in China, the disclosure of which is incorporated herein by reference in its entirety.

The present disclosure relates to the electrical field, and more particularly relates to a device and method for controlling a switch module (e.g., a switch module of a three-phase inverter), a three-phase inverter and a program product.

### BACKGROUND

A three-phase motor is a class of electric motors powered by simultaneous connection into a three-phase AC current (with a phase difference of 120 degrees). To better control the motor, an electric control unit (ECU) of the motor typically comprises a three-phase inverter (power level), etc. For example, a traction inverter is a controller of a three-phase towing motor that can receive a direct current from a power cell and convert a DC voltage and current to an alternating current according to requirements of the three-phase towing motor, thereby providing an alternating current to the three-phase towing motor.

### SUMMARY

The embodiments of the present disclosure provide a device and method for controlling a switch module, a three-phase inverter, a medium, and a program product.

In a first aspect of the present disclosure, there is provided a device for controlling a switch module, the switch module comprising a plurality of switches in parallel. The device comprises: a current acquisition module configured to acquire a total expected current flowing through a plurality of switches of the switch module; a power loss determination module configured to determine a plurality of power losses of a plurality of switch combinations when at least one switch of the plurality of switches is turned on based on the total expected current acquired; and a turn-on switch number determination module configured to determine a target number of the switches turned on for the total expected current based on the plurality of power losses determined.

In a second aspect of the present disclosure, there is provided a method for controlling a switch module, the switch module comprising a plurality of switches in parallel. The method comprises: acquiring a total expected current flowing through a plurality of switches of the switch module; determining a plurality of power losses of a plurality of switch combinations when at least one switch of the plurality of switches is turned on based on the total expected current acquired; and determining a target number of the switches turned on for the total expected current based on the plurality of power losses determined.

In a third aspect of the present disclosure, there is provided a three-phase inverter, comprising: a plurality of switch modules, each switch module comprising a plurality of switches in parallel; and the device for controlling each switch module of the plurality of switch modules according to the first aspect of the present disclosure.

In a fourth aspect of the present disclosure, there is provided a machine-readable storage medium having machine-executable instructions stored thereon, wherein the machine-executable instructions are executed by a processor to implement the steps of the method according to the second aspect.

According to a fifth aspect of the present disclosure, there is provided a machine program product that is tangibly stored on a non-volatile computer-readable medium and comprises machine-executable instructions that, when executed, cause a machine to execute the method according to the second aspect of the present disclosure.

It will be understood that the content described in the Summary is not intended to limit key or important features of the embodiments of the present disclosure, nor is it intended to limit the scope of the present disclosure. Other features of the present disclosure will become readily understood by the following description.

### BRIEF DESCRIPTION OF THE DRAWINGS

Above and other features, advantages and aspects of various embodiments of the present disclosure will become more apparent in combination with the accompanying drawings and with reference to the following detailed description. In the accompanying drawings, like or similar accompanying drawing annotations designate like or similar elements, wherein:

FIG. 1 shows a schematic diagram of an example environment in which a plurality of embodiments of the present disclosure may be implemented;

FIG. 2 shows a schematic diagram of a device for controlling a switch module according to some embodiments of the present disclosure;

FIGS. 3A-3C show schematic diagrams of a drive circuit for one switch module according to some embodiments of the present disclosure;

FIGS. 4A-4C show schematic diagrams of a drive circuit for one switch module according to some embodiments of the present disclosure;

FIG. 5 shows a method for controlling a switch module according to some embodiments of the present disclosure.

### DETAILED DESCRIPTION

The embodiments of the present disclosure will be described in further detail below with reference to the accompanying drawings. Although certain embodiments of the present disclosure are shown in the accompanying drawings, it should be understood that the present disclosure may be implemented in various forms and should not be construed as being limited to the embodiments set forth herein, rather these embodiments are provided for a more thorough and complete understanding of the present disclosure. It will be understood that the accompanying drawings and embodiments of the present disclosure are for exemplary purposes only and are not intended to limit the scope of protection of the present disclosure, and the embodiments of the present disclosure that are described below with reference to the accompanying drawings are for illustrative purposes only.

In the description of the embodiments of the present disclosure, the term “comprise” and similar terms should be understood as open-ended inclusion, meaning “including but not limited to”. The term “based on” should be understood as “at least partially based on”. The term “one embodiment” or “this embodiment” should be understood as “at least one embodiment”. The terms “first”, “second”, etc. may refer to different or the same object. Other explicit and implicit definitions may be included below.

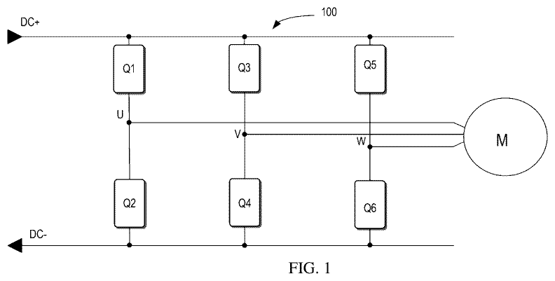

Embodiments of the present disclosure will be described in further detail below in conjunction with the accompanying drawings, wherein FIG. 1 shows an example environment in which a device of the embodiments of the present disclosure may be implemented.

As shown in FIG. 1, the three-phase inverter 100 is connected between a power cell B and a motor M, and comprises three phases connected (e.g., electrically connected) to the motor M, such as three phases including U, V, and W.

As shown in FIG. 1, the three-phase inverter 100 comprises switch modules Q1 and Q2 connected in series, a midpoint of the two switch modules is connected to U phase of the motor M, and therefore this branch is referred to as U phase of the three-phase inverter 100. The three-phase inverter 100 comprises switch modules Q3 and Q4 connected in series, a midpoint of the two switch modules is connected to V phase of the motor M, and therefore this branch is referred to as V phase of the three-phase inverter 100. The three-phase inverter 100 comprises switch modules Q5 and Q6 connected in series, a midpoint of the two switch modules is connected to W phase of the motor M, and therefore this branch is referred to as W phase of the three-phase inverter 100. As shown in FIG. 1, the three-phase inverter 100 is connected to a direct current (DC+, DC−), such as a direct current from a battery, to convert the direct current to an alternating current used in the motor.

In some embodiments, each of the switch modules Q1 to Q6 may comprise 6 switches in parallel, each switch may be an isolated grid bipolar transistor (IGBT) type switch and a metal-oxide semiconductor field-effect transistor (MOSFET) type switch. While the above illustrates that each switch module comprises 6 transistors in parallel,

those skilled in the art should be clear that any other number of transistors may also be included.

All switches (e.g., 6 switches) included in each switch module operate with the same switch, i.e., are simultaneously turned on or simultaneously turned off. In an inverter, the turn-on or turn-off behavior of each switch causes a power loss, which is called a switching loss. The current flowing through each switch when the switch is turned on also causes a power loss, which is referred to as a conducting loss. When all switches work together, there are instances (e.g., in the field of high rotational speeds) that will result in reduced efficiency.

In view of the above problems, embodiments of the present disclosure provide a device for controlling a switch module, the switch module comprising a plurality of switches. The device comprises: a current acquisition module configured to acquire a total expected current flowing through a plurality of switches of the switch module; a power loss determination module configured to determine a plurality of power losses of a plurality of switch combinations when at least one switch of the plurality of switches is turned on based on the total expected current acquired; and a turn-on switch number determination module configured to determine a target number of the switches turned on for the total expected current based on the plurality of power losses determined. The device for controlling the switch module according to the present disclosure is capable of changing the number of switches turned on in the plurality of switches according to the total expected current to achieve a lower switch power loss.

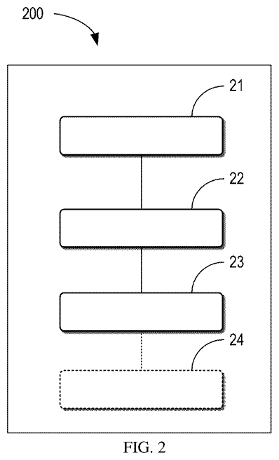

FIG. 2 shows a schematic diagram of a device for controlling a switch module (e.g., a switch module of a three-phase inverter) according to some embodiments of the present disclosure. The device 200 as shown in FIG. 2 is for each switch module of the 6 switch modules Q1 to Q6 shown in FIG. 1.

As shown in FIG. 2, the device 200 comprises: a current acquisition module 21 configured to acquire a total expected current to flow through a plurality of switches (e.g., 6 parallel switches) of a switch module (e.g., switch module Q1). This total expected current is not identical with the movement state of the electric vehicle, for example, the total expected current is larger when the motor needs to output a high torque, and the total expected current is smaller when the motor needs to output a high rotational speed. The total expected current, for example, can be acquired from a controller (not shown) of the motor, and the current acquisition module 21 may be used as at least a portion of the controller.

As shown in FIG. 2, the device 200 further comprises: a power loss determination module 22 configured to determine a plurality of power losses of a plurality of switch combinations when at least one switch of the plurality of switches is turned on based on the total expected current acquired. For example, in case that the switch module Q1 comprises 6 switches, the 6 switches may be divided into 3 groups (2 per group), or divided into 2 groups (3 per group), or divided into 6 groups (one per group). At least one group of the plurality of groups may be turned on, thereby being capable of forming a plurality of switch combinations. For example, in case that there are 6 groups, some groups in the 6 groups can be turned on, so that different numbers of switches can be turned on. A plurality of power loss values are calculated for these switch combinations respectively. For example, the power loss determination module 22 may be at least a portion of a controller (not shown) of the motor. In some embodiments, the power loss comprises the conducting loss when the switch is turned on and the switching loss when the switch state is switched. In the range of operation of the inverter, the conducting loss will prevail when the current is high (high torque), and then the switching loss will prevail when the current is low at the high rotational speed. The total power loss may be the sum of the conducting loss and the switching loss.

For a particular total expected current Iₜₒₜₐₗ, the conducting loss Pcond can be calculated with the following equation (1):

$${P}_{cond} = {I}_{total}^{2} * {R}_{DS , on} / {n}_{enable} \qquad ( 1 )$$

where R_{DS,ON} is the conducting resistance of each switch, n_{enable} is the number of switches that are turned on by enabling in each switch module (e.g., a switch module Q1 comprising 6 switches), and Iₜₒₜₐₗ is the sum of currents passing through all switches of each switch module. It can be seen from this that the conducting power loss Pcond is the second-order equation of currents and is inversely proportional to the number of switches turned on. The fewer the switches being turned on by enabling, the greater the conducting loss; and the more the switches being turned on by enabling, the less the conducting loss.

For a particular total expected current Itotal, the switching loss P_{SW} can be calculated with the following equation (2):

$${P}_{sw} = {f}_{sw} * ( A + B * \frac{{I}_{total}}{{n}_{enable}} + C * {( \frac{{I}_{total}}{{n}_{enable}} )}^{2} ) * {n}_{enable} \qquad ( 2 )$$

where A, B, and C are constant factors associated with the characteristics of the switches, f_{SW} is the switching or switch frequency of the switches, n_{enable} is the number of switches that are turned on by enabling in each switch module (e.g., switch module Q1), and Iₜₒₜₐₗ is the sum of the currents passing through all switches of each switch module. It can be seen from the above equation (2) that the switching loss is related to the constant deviation and the first and second orders of the total current, and is not in a simple positive-to-reverse relationship to the number of switches being turned on. Thus, the switching loss P_{SW} correlates to the product of the switching loss

$$( A + B * \frac{{I}_{total}}{{n}_{enable}} + C * {( \frac{{I}_{total}}{{n}_{enable}} )}^{2} )$$

of each switch and the number of switches turned on n_{enable}, wherein the switching loss

$$( e . g . , A + B * \frac{{I}_{total}}{{n}_{enable}} + C * {( \frac{{I}_{total}}{{n}_{enable}} )}^{2} )$$

of each switch is inversely proportional to the number of switches turned on n_{enable}.

It is to be noted that the equations (1) and (2) here are only some examples for calculating power losses, and other power loss calculation methods can also be achieved. As can be seen from the equation, the power loss correlates with the current Iₜₒₜₐₗ flowing through all switches, parameters (e.g., A, B, C) of a particular switch, and the number of switches turned on. The conducting power loss is the second-order equation of the current, and the switching loss consists of the constant deviation and the first and second orders of the current. If the numbers of switches turned on are different, the determined conducting losses and switching losses are also different.

As shown in FIG. 2, the device 200 also comprises a turn-on switch number determination module 23 configured to determine a target number of the total expected current based on the plurality of power losses determined. For example, the turn-on switch number corresponding to the lowest power loss in the plurality of power losses is selected as the target number. The turn-on switch number determination module 23 may also serve as at least a portion of a controller (not shown) of the motor.

In some embodiments, as shown in FIG. 2, the device 200 also comprises a drive circuit 24. The plurality of switches (e.g., 6 switches in the switch module Q1) are grouped into a plurality of groups (e.g., 3 groups, 2 groups or 6 groups), each group of switches comprises at least one switch, each group of switches is controlled by one respective drive circuit, and a plurality of drive circuits are configured to turn on or turn off at least some of the plurality of switches based on the target number of switches determined by the turn-on switch number determination module 23. That is, how many groups the plurality of switches are divided into, how many drive circuits the device 200 comprises.

In some embodiments, the drive circuit 24 may receive an enable signal from the turn-on switch number determination module 23. For example, in the presence of 6 groups of switches, for a particular total expected current, it is determined that the total loss is minimum when 4 switches are turned on, so the enable signal produced by the turn-on switch number determination module 23 may cause 4 drive circuits 24 to be enabled, and the remaining 2 drive circuits 24 can be deactivated, thereby ensuring that only 4 switches are turned on.

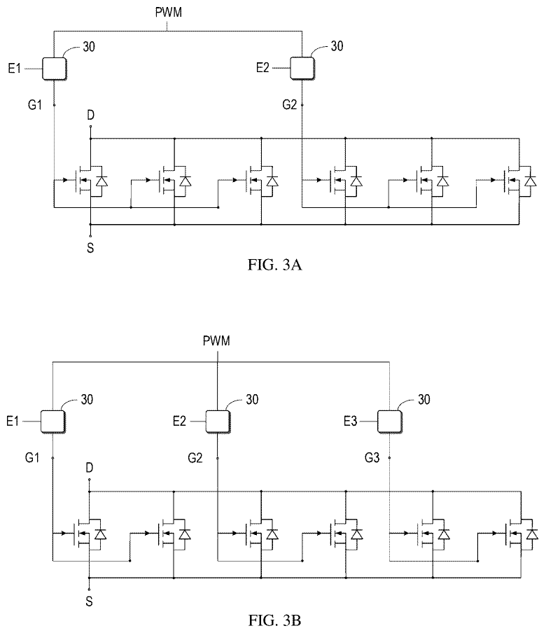

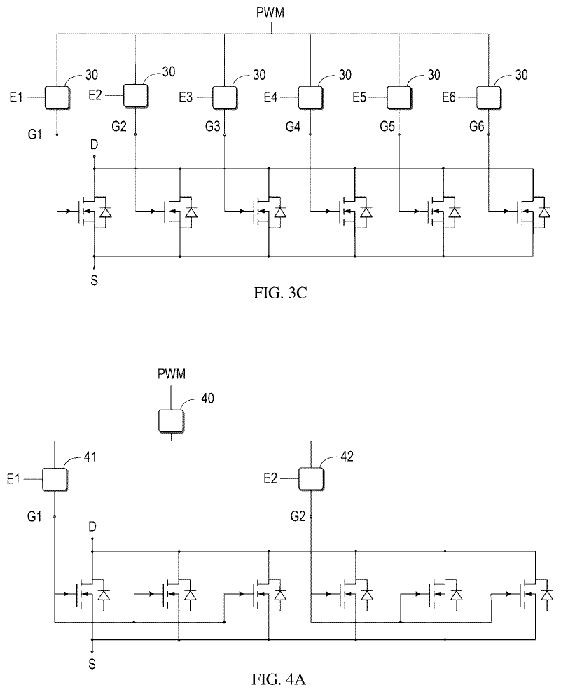

FIGS. 3A-3C show schematic diagrams of a drive circuit for one switch module Q1 according to some embodiments of the present disclosure. While the drive circuit is shown for the switch module Q1, those skilled in the art should understand that other switch modules Q2 to Q6 can comprise the same drive circuit. A schematic diagram of the drive circuit of the switch module Q1 will be described below with a type of switch.

As shown in FIG. 3A, the 6 switches in the switch module Q1 are divided into 2 groups, with each group comprising 3 switches. In some embodiments, the drive circuit for the switch module Q1 of FIG. 3A may comprise two gate drivers 30, the two gate drivers 30 are enabled or deactivated by the enable signals E1 and E2 from, for example, a switch number determination module 23, to control a gate of a respective switch. Further, the 2 gate drivers may be controlled by a same pulse width modulation (PWM) signal, such that when a gate port is at a high voltage (e.g., 15 V) and the respective gate driver 30 is enabled, the switch will be turned on, the current may flow from a drain to a source, and when the respective gate driver 30 is enabled and the gate port is at a low voltage (e.g., 0 V), the switch will be turned off and the current cannot flow from the drain to the source. For the switches that the gate driver 30 is deactivated by the enable signals, these switches are always in a turn-off state and cannot be turned on.

In some embodiments, one respective gate driver 30 may be connected to a gate of each switch of the group of switches it controls via a gate port of the switch module Q1 connected to an external circuit. Thus, as shown in FIG. 3A, the switch module Q1 has 4 ports connected to an external circuit, for example, a first port represents a gate port G1 of the first group of switches, a second port represents a gate port G2 of the second group of switches, a third port represents a source port S of all switches, and a fourth port represents a drain port D of all switches.

As shown in FIG. 3B, 6 switches in the switch module Q1 are divided into 3 groups, with each group comprising 2 switches. In some embodiments, the drive circuit for the switch module Q1 of FIG. 3B may comprise three gate drivers 30, the three gate drivers 30 are enabled or deactivated by the enable signals E1, E2, and E3, respectively, to control gates of the respective switches. Further, the 3 gate drivers may be controlled by the same pulse width modulation PWM signal, such that when a gate port is at a high voltage (e.g., 15 V) and the respective gate driver 30 is enabled, the switch will be turned on, the current may flow from the drain to the source, and when the respective gate driver 30 is enabled and the grid port is at a low voltage (e.g., 0 V), the switch will be turned off and the current cannot flow from the drain to the source. For the switches that the gate driver 30 is deactivated by the enable signals, these switches are always in a turn-off state and cannot be turned on.

In some embodiments, one respective gate driver 30 may be connected to the gate of each switch in the group of switches that it controls by a gate port that is connected to an external circuit through the switch module Q1. Thus, as shown in FIG. 3B, the switch module Q1 has 5 ports connected to an external circuit, for example, a first port represents a gate port G1 of a first group of switches, a second port represents a gate port G2 of a second group of switches, a third port represents a gate port G3 of a third group of switches, a fourth port represents a source port S of all switches, and a fifth port represents a drain D of all switches.

As shown in FIG. 3C, the 6 switches in the switch module Q1 are divided into 6 groups, with each group only comprising 1 switch. In some embodiments, the drive circuit for the switch module Q1 of FIG. 3C may comprise, therefore, 6 gate drivers 30, the 6 gate drivers 30 are enabled or deactivated by enable signals E1, E2, E3, E4, E5 and E6 of the switch number determination module 23 respectively to control the gates of the respective switches. Further, the 6 gate drivers may be controlled by the same pulse width modulation signal, such that when the respective gate driver 30 is enabled and the gate port is at a high voltage (e.g., 15 V), the switch will be turned on, the current may flow from the drain to the source, and when the respective gate driver 30 is enabled and the gate port is at a low voltage (e.g., 0 V), the switch will be turned off and the current cannot flow from the drain to the source. For the switches that the gate driver 30 is deactivated by the enable signals, these switches are always in a turn-off state and cannot be turned on.

In some embodiments, one respective gate driver 30 may be connected to a gate of each switch in the group of switches it controls via a gate port of the switch module Q1 connected to an external circuit. Thus, as shown in FIG. 3C, the switch module Q1 has 8 ports connected to an external circuit, for example, the first port represents a gate port G1 of the first switch, the second port represents a gate port G2 of the second switch, the third port represents a gate port G3 of the third switch, the fourth port represents a gate port G4 of the fourth group of switches, the fifth port represents a gate port G5 of the fifth switch, the sixth port represents a gate port G6 of the sixth switch, the seventh port represents a source port S of all switches, and the eighth port represents a drain port D of all switches.

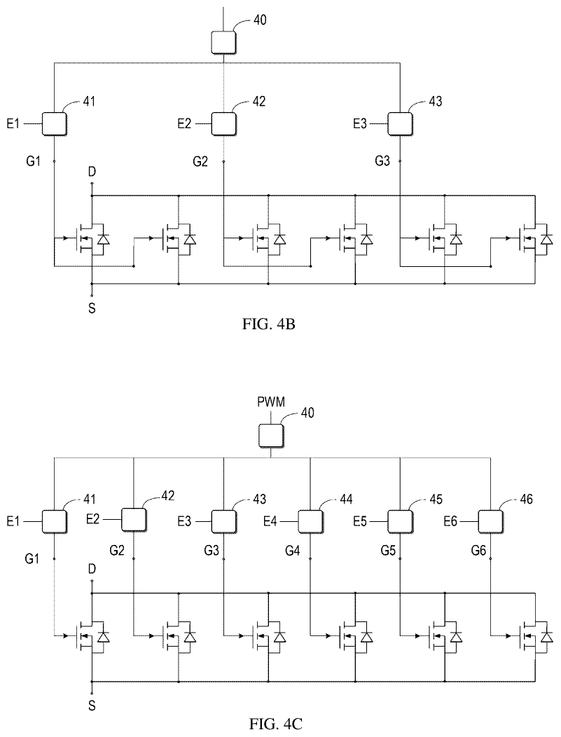

FIGS. 4A-4C show schematic views of a drive circuit for a switch module Q1 according to some embodiments of the present disclosure.

In some embodiments, as shown in FIG. 4A, the 6 switches in the switch module Q1 are divided into 2 groups, with each group comprising 3 switches. In some embodiments, the drive circuit for the switch module Q1 of FIG. 4A may comprise a gate driver 40 and 2 push-and-pull integrated circuits 41 and 42 connected to the gate driver 40. The 2 push-and-pull integrated circuits 41 and 42 are enabled or deactivated by the enable signals E1 and E2 from, for example, the switch number determination module 23, respectively, to control the gate of the respective switch. In addition, the 2 push-and-pull integrated circuits 41 and 42 may be controlled by the same pulse width modulation signal PWM.

The gate driver 40 is connected to a pulse width modulation signal, and each push-and-pull integrated circuit is configured to convert the pulse width modulation (PWM) signal to a square wave with a higher voltage and current in order to successfully drive the respective switch. For example, when the current demand of the gate port is higher than the current limit of the gate driver 40, a push-and-pull integrated circuit is used to increase the current of the gate driver 40. In some embodiments, the push-and-pull integrated circuit comprises two p-type transistors and n-transistors which are controlled by the same signal.

When the respective push-and-pull integrated circuit is enabled and the gate port is at a high voltage (e.g., 15 V), the switch will be turned on, the current may flow from the drain to the source, and when the push-and-pull integrated circuit is enabled and the gate port is at a low voltage (e.g., 0 V), the switch will be turned off and the current cannot flow from the drain to the source. For the switches that the push-and-pull integrated circuit is deactivated by the enable signals, these switches are always in a turn-off state and cannot be turned on.

In some embodiments, as shown in FIG. 4B, the 6 switches in the switch module Q1 are divided into 3 groups, with each group comprising 2 switches. In some embodiments, the drive circuit for the switch module Q1 of FIG. 4B may comprise a gate driver 40 and 3 push-and-pull integrated circuits 41 to 43 connected to the gate driver 40. The 3 push-and-pull integrated circuits 41 to 43 are respectively enabled or deactivated by the enable signals E1 to E3 from, for example, the switch number determination module 23 to control the gate of the respective switch. In addition, the 3 push-and-pull integrated circuits 41 to 43 may be controlled by the same pulse width modulation PWM signal.

When the respective push-and-pull integrated circuit is enabled and the gate port is at a high voltage (e.g., 15 V), the switch will be turned on, the current may flow from the drain to the source, and when the push-and-pull integrated circuit is enabled and the gate port is at a low voltage (e.g., 0 V), the switch will be turned off and the current cannot flow from the drain to the source. For the switches that the push-and-pull integrated circuit is deactivated by the enable signals, these switches are always in a turn-off state and cannot be turned on.

In some embodiments, as shown in FIG. 40, 6 switches in the switch module Q1 are grouped into 6 groups, so that the number of drive circuits is 6. Each drive circuit comprises a gate driver 40 and 6 push-and-pull integrated circuits 41 to 46 connected to the gate driver 40, and therefore each push-and-pull integrated circuit controls 1 switch. Each push-and-pull integrated circuit is controlled by a respective enable signal (e.g., from the turn-on switch number determination module 23) to achieve turn-on, e.g., the push-and-pull integrated circuit 41 is driven by the enable signal E1, the push-and-pull integrated circuit 42 is driven by the enable signal E2, the push-and-pull integrated circuit 43 is driven by the enable signal E3, the push-and-pull integrated circuit 44 is driven by the enable signal E4, the push-and-pull integrated circuit 45 is driven by the enable signal E5, and the push-and-pull integrated circuit 46 is driven by the enable signal E6.

When the respective push-and-pull integrated circuit is enabled and the gate port is at a high voltage (e.g., 15 V), the switch will be turned on, the current may flow from the drain to the source, and when the push-and-pull integrated circuit is enabled and the gate port is at a low voltage (e.g., 0 V), the switch will be turned off and the current cannot flow from the drain to the source. For the switches that the push-and-pull integrated circuit is deactivated by the enable signals, these switches are always in a turn-off state and cannot be turned on.

It should be noted that the examples shown in FIGS. 4A-4C also apply to the case that the switch module comprises other numbers of switches.

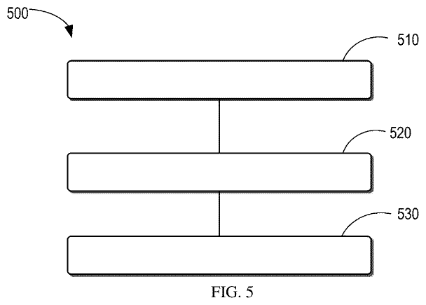

FIG. 5 shows a method for controlling a switch module (e.g., a switch module of a three-phase inverter) according to some embodiments of the present disclosure. The switch module comprises a plurality of switches in parallel. In block 510, a total expected current flowing through a plurality of switches of the switch module is acquired. For example, the total expected current may be acquired from a controller of a motor controlled by a three-phase inverter. In block 520, a plurality of power losses for a plurality of switch combinations when at least one switch of the plurality of switches is turned on are determined based on the total expected current acquired. For example, in case that the switch module comprises 6 switches, only 1 switch, 2 switches, 3 switches, 4 switches, 5 switches or 6 switches may be turned on, and if the numbers of switches turned on are different, the power losses are different, so a plurality of power losses may be calculated. In block 530, a target number of the switches turned on for the total expected current is determined based on the plurality of power losses determined. For example, the turn-on switch number corresponding to the lowest power loss may be selected to determine the target number, for example, for the plurality of power losses mentioned above, it is determined that the power loss is lowest when 3 switches are turned on, and the target number is determined as 3.

In some embodiments, the method 500 may further comprise, based on the determined target number, generating an enable signal provided to a drive circuit of the switch module, wherein a target number of switches in the plurality of switches are turned on by the drive circuit based on the enable signal.

Although the present subject matter has been described in languages that are specific to structural features and/or method logical actions, it should be understood that the subject matter defined in the appended claims is not necessarily limited to the particular features or actions described above. Rather, the particular features and actions described above are merely example forms of implementing the claims.

The flow charts and block diagrams in the accompanying drawings show the system architecture, functions and operations that may be implemented based on the systems, methods and computer program products according to the plurality of embodiments of the present disclosure. Regarding this, every block in the flow charts or block diagrams can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in a reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and computer instructions.

The various embodiments of the present disclosure have been described above. The descriptions provided are exemplary and not exhaustive, and they are also not limited to the disclosed embodiments. Many modifications and variations will be apparent to those skilled in the art without departing from the scope and spirit of the described embodiments. The selection of terms used in this text aims to best explain the principles and actual application of the various embodiments, the improvements in the technology in the market, or allow others of ordinary skill in the art to understand various embodiments disclosed in this text.

What is claimed is:

1. A device for controlling a switch module, the switch module having a plurality of switches in parallel, the device comprising:
a current acquisition module configured to acquire a total expected current flowing through the plurality of switches of the switch module;
a power loss determination module configured to determine a plurality of power losses of a plurality of switch combinations when at least one switch of the plurality of switches is turned on based on the total expected current acquired; and
a turn-on switch number determination module configured to determine a target number of switches turned on for the total expected current based on the plurality of power losses determined.

2. The device according to claim 1, wherein:
the plurality of switches is divided into at least two sets of switches, and
each group of switches in the at least two groups of switches are electrically connected to the device through a respective gate port to be controlled by the device.

3. The device according to claim 2, further comprising at least two drive circuits configured to turn on the target number of switches in the at least two groups of switches based on the target number determined, wherein each drive circuit is connected to a respective gate port of each group of switches.

4. The device according to claim 3, wherein:
the at least two drive circuits comprise at least two gate drivers configured to be enabled or deactivated based on an enable signal of the turn-on switch number determination module to turn on the target number of switches in the plurality of switches through a gate driver enabled, and
each gate driver is connected to a gate of each switch in each group of switches via a respective gate port.

5. The device according to claim 3, wherein the at least two drive circuits comprise:
a gate drive circuit; and
at least two push-and-pull integrated circuits connected between the gate drive circuit and the gate of the plurality of switches, and configured to receive an enable signal of the turn-on switch number determination module to be enabled or deactivated to turn on the target number of switches in the plurality of switches through the push-and-pull integrated circuits enabled,
wherein each push-and-pull integrated circuit is connected to a gate of each switch in each group of switches through a respective gate port.

6. The device according to claim 1, wherein the device is configured to control a plurality of switch modules included in a three-phase inverter.

7. The device according to claim 3, wherein the device for controlling each switch module in a plurality of switch modules included in a three-phase inverter comprises the at least two drive circuits.

8. The device according to claim 1, wherein:
the power loss comprises conducting losses of the plurality of switches and switching losses of the plurality of switches,
the conducting losses of the plurality of switches are inversely proportional to a number of switches turned on,
the switching losses are associated with a product of the switching loss of each switch and the number of switches turned on, and
the switching loss of each switch is inversely proportional to the number of switches turned on.

9. A method for controlling a switch module, the switch module having a plurality of switches in parallel, the method comprising:
acquiring a total expected current flowing through the plurality of switches of the switch module;
determining a plurality of power losses of a plurality of switch combinations when at least one switch of the plurality of switches is turned on based on the total expected current acquired; and
determining a target number of the switches turned on for the total expected current based on the plurality of power losses determined.

10. The method according to claim 9, wherein:
the power losses comprise conducting losses of the plurality of switches and switching losses of the plurality of switches,
the conducting losses of the plurality of switches are inversely proportional to the number of switches turned on, and the switching losses are associated with a product of the switching loss of each switch and the number of switches turned on, and
the switching loss of each switch is inversely proportional to the number of switches turned on.

11. The method according to claim 9, further comprising:
generating an enable signal provided to a drive circuit of the switch module based on the target number determined; and
enabling or deactivating the drive circuit based on the enable signal to turn on the target number of switches in the plurality of switches.

12. The method according to claim 11, wherein:
the drive circuit comprises at least two gate drivers connected to a gate of the plurality of switches, and
enabling or deactivating the drive circuit based on the enable signal to turn on the target number of switches in the plurality of switches comprises enabling or deactivating the at least two gate drivers based on the enable signal to turn on the target number of switches in the plurality of switches through the gate drivers enabled.

13. The method according to claim 11, wherein the drive circuit comprises:
a gate drive circuit; and
at least two push-and-pull integrated circuits connected between the gate drive circuit and a gate of the plurality of switches,
wherein enabling or deactivating the drive circuit based on the enable signal to turn on the target number of switches in the plurality of switches comprises enabling or deactivating the at least two push-and-pull integrated circuits based on an enable signal to turn on the target number of switches in the plurality of switches through the push-and-pull integrated circuits enabled.

14. A three-phase inverter, comprising:
a plurality of switch modules, each switch module comprising a plurality of switches in parallel; and
the device for controlling each switch module in a plurality of switch modules according to claim 1.

15. A machine program product, the computer program product being tangibly stored on a non-volatile computer-readable medium and comprising machine-executable instructions that, when executed, cause a machine to execute the method according to claim 9.
